(19) United States
(12) Patent Application Publication
(10) Pub. No.: US 2002/0162919 A1
(43) Pub. Date: Nov. 7, 2002

(54) Wrist rest apparatus having a solid structure

(76) Inventor: Chun Fu Kuo, Taichung (TW)

Correspondence Address: CHARLES E. BAXLEY, ESQ, 59 JOHN STREET FIFTH FLOOR, NEW YORK, NY, 10038, US

(21) Appl. No.: 09/849,469

(22) Filed: May 2, 2001

(51) Int. Cl. B68G 5/00

(52) U.S. Cl. 248/118

(57) ABSTRACT

A wrist rest device includes a base having a recess formed in a peripheral wall, a wrist rest having a lower portion received in the recess of the base, and a covering engaged on the wrist rest and having a peripheral skirt engaged into the base, for solidly securing the wrist rest on the base. The lower portion of the wrist rest has a width smaller than that of the peripheral wall of the base for forming a peripheral channel between the wrist rest and the peripheral wall of the base. The peripheral wall may prevent the wrist rest from being broken relative to the base.

### BACKGROUND OF THE INVENTION

1. Field of the Invention

The present invention relates to a wrist rest apparatus, and more particularly to a wrist rest apparatus including a solid structure.

2. Description of the Prior Art

Various kinds of typical wrist rest apparatuses have been developed and disposed in front of the computer or the keyboard for comfortably supporting the wrist portion of the users. FIGS. 1 and 2 illustrate one of the typical wrist rest apparatuses and comprise a wrist rest 92 formed on top or extended upward from a planer base 91 and having a substantially 90-degree angle formed between the wrist rest 92 and the planer base 91. A stress concentration may be formed in the 90-degree angle that is formed between the wrist rest 92 and the planer base 91, such that the wrist rest 92 may be broken and disengaged from the planer base 91 after use.

U.S. Pat. No. 5,566,913 to Prokop discloses the other typical wrist rest apparatus which is shown in FIGS. 3 and 4. The typical wrist rest apparatus also comprises a planer base 91 including a depression 94 formed therein, for receiving a wrist rest 92 therein. The wrist rest 92 is normally made of a softer material than that for the planer base 91, and is required to be molded onto the planer base 91 with another mold device. Or, relatively, the planer base 91 is required to be molded onto the wrist rest 92 with another mold device, such that the typical wrist rest apparatus may not be quickly made. In addition, the wrist rest 92 may not be solidly secured on the planer base 91 and may also be easily broken and disengaged from the planer base 91 after use.

The present invention has arisen to mitigate and/or obviate the afore-described disadvantages of the conventional wrist rest apparatuses.

### SUMMARY OF THE INVENTION

The primary objective of the present invention is to provide a wrist rest apparatus including a wrist rest that may be solidly secured on the base and will not be disengaged from the base.

In accordance with one aspect of the invention, there is provided a wrist rest apparatus comprising a base including a peripheral wall extended upward therefrom for defining a recess within the peripheral wall, a wrist rest including a lower portion received in the recess of the base and including an upper peripheral portion, and a covering engaged onto the upper peripheral portion of the wrist rest and including a peripheral skirt extended beyond the wrist rest and engaged into the base, by such as a molding process, such that the wrist rest may be solidly secured on the base with the covering. The lower portion of the wrist rest includes a width smaller than that of the peripheral wall of the base for defining a peripheral channel between the wrist rest and the peripheral wall of the base. The peripheral wall of the base may engage with the wrist rest when the wrist rest is depressed by the users, in order to prevent the wrist rest from being disengaged or broken relative to the base.

Further objectives and advantages of the present invention will become apparent from a careful reading of a detailed description provided hereinbelow, with appropriate reference to accompanying drawings.

### BRIEF DESCRIPTION OF THE DRAWINGS

FIG. 1 is a partial perspective view of a typical wrist rest apparatus;

FIG. 2 is a partial cross sectional view showing the wrist rest apparatus as shown in FIG. 1;

FIG. 3 is an exploded view showing another typical wrist rest apparatus;

FIG. 4 is a cross sectional view showing the wrist rest apparatus as shown in FIG. 3;

FIG. 5 is a partial perspective view of a wrist rest apparatus in accordance with the present invention;

FIG. 6 is a cross sectional view taken along lines 6-6 of FIG. 5;

FIG. 7 is a cross sectional view similar to FIG. 6, illustrating the other embodiment of the wrist rest apparatus;

FIG. 8 is a partial perspective view showing a mold device for forming or manufacturing the wrist rest apparatus in accordance with the present invention;

FIG. 9 is a cross sectional view taken along lines 9-9 of FIG. 8; and

FIGS. 10, 11 are cross sectional views similar to FIG. 9, illustrating the formation or the manufacturing of the wrist rest apparatus.

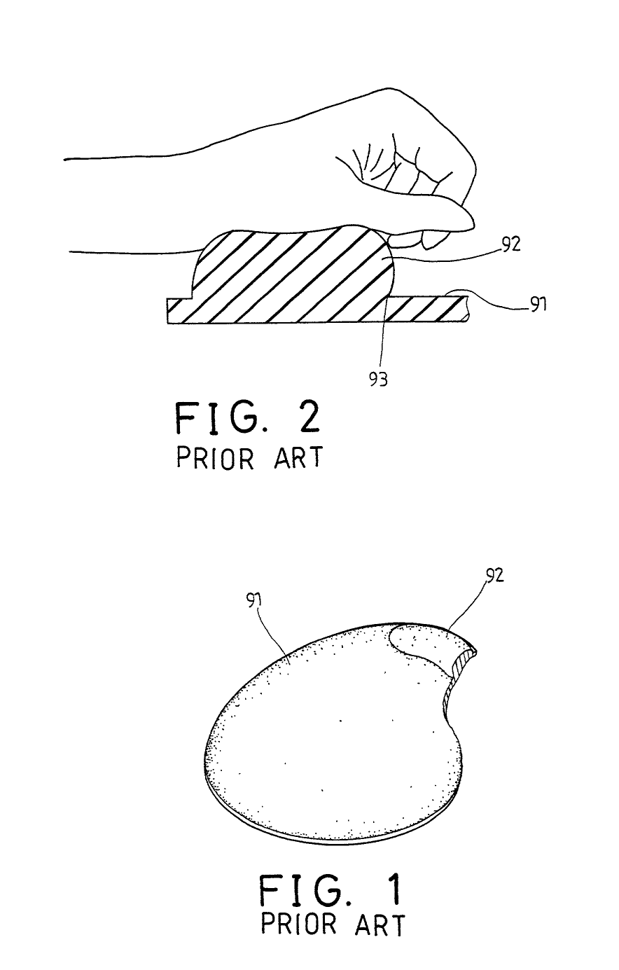

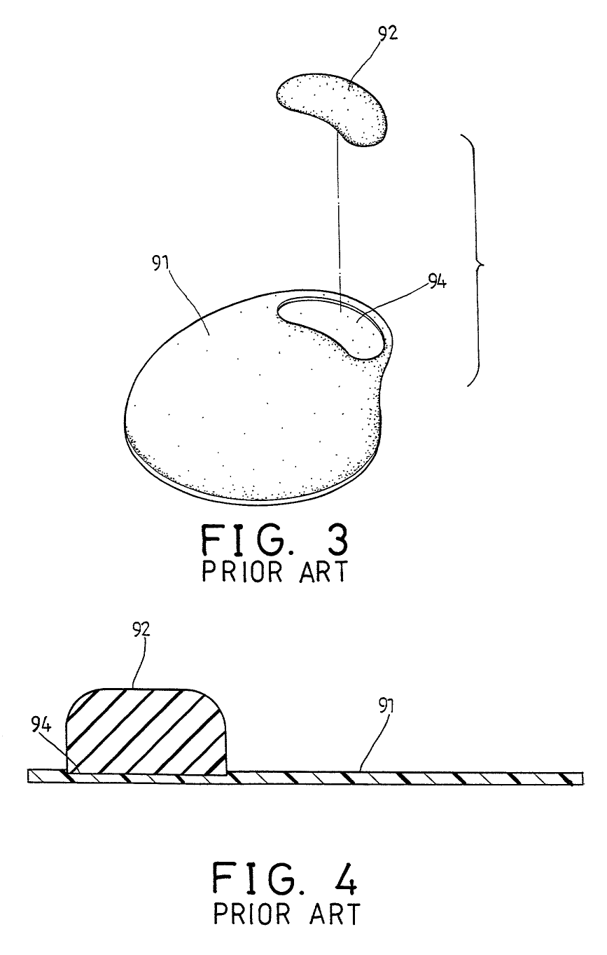

### DETAILED DESCRIPTION OF THE PREFERRED EMBODIMENT

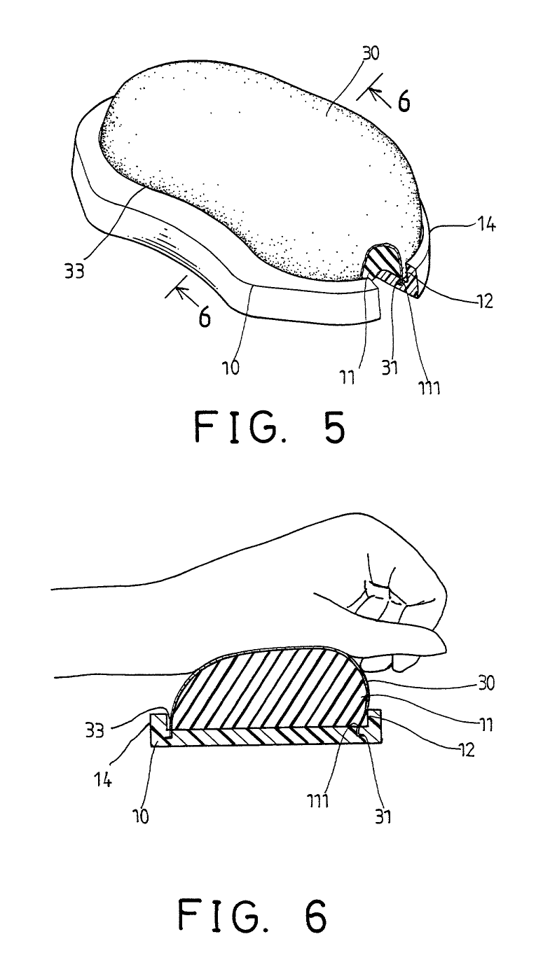

Referring to the drawings, and initially to FIGS. 5 and 6, a wrist rest apparatus in accordance with the present invention comprises a base 10 including a recess 12 formed therein and defined by a peripheral wall 14, or including the peripheral wall 14 extended upward therefrom for forming or defining the recess 12 therein. A wrist rest 11 is formed or provided on top of the base 10 and includes a lower portion 111 received in the recess 12 and located within the peripheral wall 14. A covering 30 is engaged on the outer or upper peripheral portion of the wrist rest 11 and includes a lower peripheral skirt 31 extended downward beyond the wrist rest 11 and engaged in or molded in the base 10 in a molding process, for example. As best shown in FIG. 6, the lower portion 111 of the wrist rest 11 includes a diameter or a width or a length or the like smaller than the inner diameter or width or the length of the recess 12 of the base 10 for forming or defining a peripheral channel 33 between the wrist rest 11 and the peripheral wall 14 of the base 10.

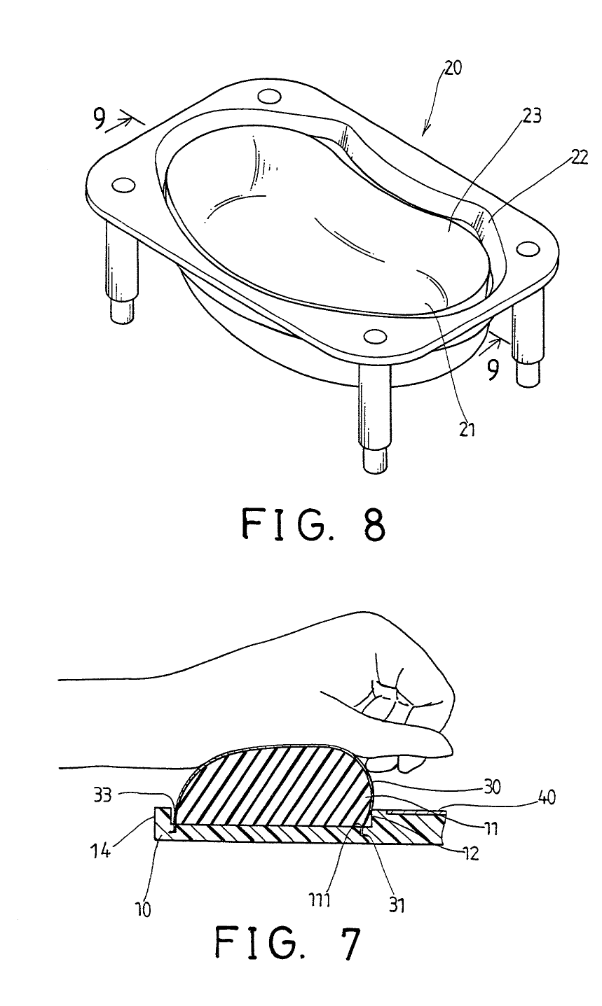

The wrist rest 11 is preferably made of softer material, such as the gel, the spongy materials, the foamable materials, the silicone materials, the synthetic materials, such as the polyurethane, the polyether, or the like. The base 10 may be made of the materials similar to that of the wrist rest 11, but may include a greater hardness than that of the wrist rest 11 for forming a stronger or a solid supporting structure. As shown in FIG. 7, the base 10 may include a harder plate 40 formed or molded on top of the base 10 for supporting the mouse of the computer.

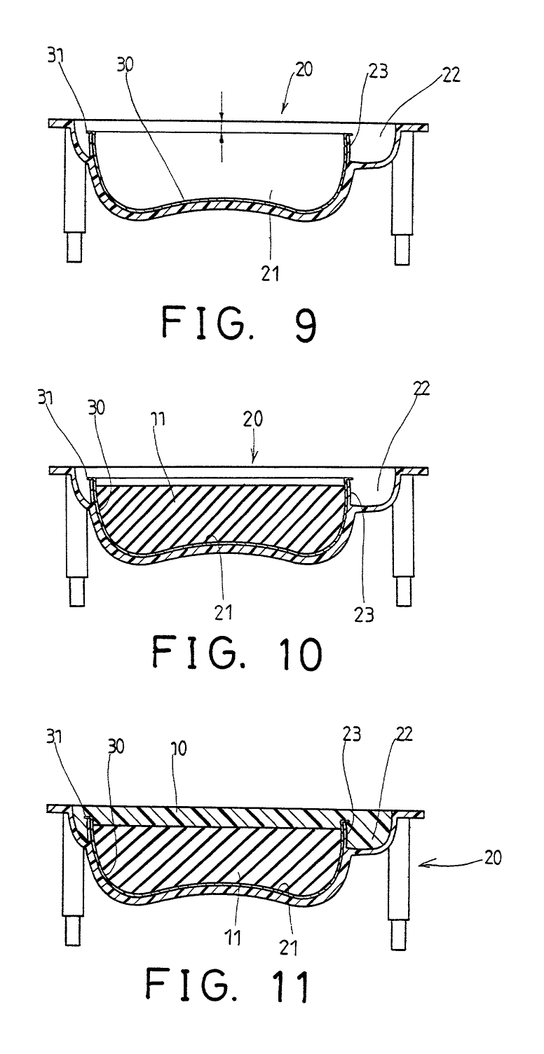

Referring next to FIGS. 8-11, illustrated is a mold device 20 for forming or manufacturing the wrist rest apparatus in accordance with the present invention. The mold device 20 includes a mold cavity 21 formed in the middle portion thereof, and includes a peripheral partition 23 extended upward therefrom, and includes a peripheral groove 22 formed around the peripheral partition 23. The covering 30 is applied or engaged on the bottom of the mold cavity 21 of the mold device 20, and the peripheral skirt 31 of the covering 30 is folded and engaged on the peripheral partition 23. The material for forming the wrist rest 11 is firstly filled into the mold cavity 21 and has an upper surface lower than the top of the peripheral partition 23 (FIG. 10). The material for forming the base 10 is then filled into the mold cavity 21 and onto the wrist rest 11 and filled in the peripheral groove 22 of the mold device 20 (FIG. 11), such that the base 10 may be formed or molded onto the wrist rest 11 with a single mold device 20. The peripheral skirt 31 of the covering 30 may thus be engaged into or molded into the base 10 in the molding process, such that the covering 30 may be solidly secured to the base 10, and such that the wrist rest 11 may be solidly secured to the base 10 with the covering 30.

In operation, as shown in FIGS. 6 and 7, when the wrist rest 11 is depressed by the users, the peripheral wall 14 of the base 10 may suitably retain the wrist rest 11 within the recess 12 of the base 10. In addition, the covering 30 may solidly secure the wrist rest 11 to the base 10 with the molding or engagement of the peripheral skirt 31 of the covering 30 in the base 10. The peripheral wall 14 of the base 10 may engage with the wrist rest 11 when the wrist rest 11 is depressed by the users, for preventing the wrist rest 11 from being disengaged or broken relative to the base 10.

Accordingly, the wrist rest apparatus in accordance with the present invention includes a wrist rest that may be solidly secured on the base and will not be disengaged from the base.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A wrist rest apparatus comprising:
a base including a peripheral wall extended upward therefrom for defining a recess within said peripheral wall,
a wrist rest including a lower portion received in said recess of said base and including an upper peripheral portion, and
a covering engaged onto said upper peripheral portion of said wrist rest.

2. A wrist rest apparatus comprising:
a base including a peripheral wall extended upward therefrom for defining a recess within said peripheral wall,
a wrist rest including a lower portion received in said recess of said base and including an upper peripheral portion, and
a covering engaged onto said upper peripheral portion of said wrist rest and including a peripheral skirt extended beyond said wrist rest and engaged into said base, for solidly securing said wrist rest on said base.

3. A wrist rest apparatus comprising:
a base including a peripheral wall extended upward therefrom for defining a recess within said peripheral wall,
a wrist rest including a lower portion received in said recess of said base and including an upper peripheral portion, and
a covering engaged onto said upper peripheral portion of said wrist rest and including a peripheral skirt extended beyond said wrist rest and engaged into said base, for solidly securing said wrist rest on said base,
said lower portion of said wrist rest including a width smaller than that of said peripheral wall of said base for defining a peripheral channel between said wrist rest and said peripheral wall of said base.
